(19) United States
(12) Patent Application Publication
(10) Pub. No.: US 2024/0339718 A1
(43) Pub. Date: Oct. 10, 2024

(54) CELL DEGASSING CHANNEL, BATTERY ARRANGEMENT, AND METHOD FOR DISCHARGING GASES FROM A BATTERY

(71) Applicant: AUDI AG, Ingolstadt (DE)

(72) Inventors: Carsten LORENZ, Reichertshofen (DE); Luca OLMO, Ingolstadt (DE); Paul SCHNEIDER, Großmehring (DE)

(73) Assignee: AUDI AG, Ingolstadt (DE)

(21) Appl. No.: 18/700,047

(22) PCT Filed: Sep. 30, 2022
(86) PCT No.: PCT/EP2022/077258

§ 371 Date: Apr. 10, 2024

(30) Foreign Application Priority Data
Oct. 25, 2021 (DE) 102021127619.5

(51) Int. Cl. H01M 50/358; H01M 50/249; H01M 50/342

(52) U.S. Cl. CPC H01M 50/358; H01M 50/249; H01M 50/3425

(57) ABSTRACT

A cell degassing channel for discharging gases from a battery with at least one battery cell. The cell degassing channel has a chamber which has at least one inlet opening and at least one outlet opening and which is designed such that a gas exiting from the at least one battery cell can be introduced into the chamber through the at least one inlet opening and can be led through the same along at least one gas discharge path to at least one outlet opening of the chamber. The chamber has at least one first perforated plate which is arranged in an interior space of the chamber and has multiple first holes.

### FIELD

The invention relates to a cell degassing channel for discharging gases from a battery with at least one battery cell, wherein the cell degassing channel has a chamber which has at least one inlet opening and one outlet opening and which is designed such that a gas emerging from the at least one battery cell passes through the at least one inlet opening can be introduced into the chamber, can be led through the same along at least one gas discharge path to at least one outlet opening of the chamber, and can be led out of the at least one outlet opening. Furthermore, the invention also relates to a battery arrangement and to a method for discharging a gas from a battery.

### BACKGROUND

Batteries for electric and hybrid vehicles, in particular high-voltage batteries, are known from the prior art. Such high-voltage batteries typically have a large number of battery cells, which under certain circumstances can also be combined to form cell modules. In the event of a defect in a battery cell, for example in the event of a short circuit, there is a risk that such a battery cell will go into thermal runaway mode. In the event of such a thermal runaway, the battery cell typically outgases, wherein particles from the cell are also carried along with the gas flow. To enable a defined outgassing of a battery cell, the battery cells typically have exposable degassing openings in the form of bursting membranes, for example. To prevent the particles released when a cell outgases from settling uncontrollably in the battery system, which can lead to blockage of flow cross-sections and short circuits of other cells within the battery, the gas escaping from the cells should be removed in a controlled manner, for example via a cell degassing channel. Another problem is that the gases can self-ignite when they exit the battery system, for example discharged via the cell degassing channel mentioned. This is due, on the one hand, to the high gas temperature and, on the other hand, to the hot particles contained in the gas. Accordingly, it would be desirable to be able to reduce the exit temperature of such a harmful gas and the particles contained therein to such an extent that the escape of a flame from the battery system or spontaneous ignition of the gas outside the battery or the motor vehicle can be ruled out.

For this purpose, DE 10 2011 105 981 A1 describes a lithium-ion battery defect prevention system according to which the battery cell gas is treated in the combustion engine exhaust system. Among other things, a blower or air pump is required to feed the battery exhaust gas to the exhaust system. The main problem with such active elements is that their functionality cannot be guaranteed in the event of a motor vehicle accident. If these are defective or their if functionality is impaired, the battery gas cannot be properly discharged, which can have fatal consequences.

Furthermore, DE 10 2018 125 446 A1 describes a battery housing for accommodating one or more battery modules with a housing section for partially delimiting the housing interior, wherein the housing section has an integrated exhaust duct for discharging media that escape from a battery module in the event of a defect. The exhaust duct has at least one deflection area which is designed to change the transport direction of the media. The deflection slows down any carried-away particles. It is intended that sparks that can ignite the exhaust gas are prevented from leaving the battery housing.

Nevertheless, there are still efforts to make the removal of harmful gases from a battery even more efficient and safer.

### SUMMARY

It is therefore the object of the present invention to provide a cell degassing channel, a battery arrangement, and a method which enable gases escaping from a battery cell to be discharged in the safest and most efficient manner possible.

A cell degassing channel according to the invention for discharging gases from a battery with at least one battery cell has a chamber which has at least one inlet opening and at least one outlet opening and which is designed such that a gas emerging from the at least one battery cell passes through the at least one inlet opening can be introduced into the chamber, can be led through the same along at least one gas discharge path to at least one outlet opening of the chamber, and can be led out of the at least one outlet opening. The chamber has at least one first perforated plate which is arranged in an interior space of the chamber and has multiple first holes, wherein the chamber is designed such that the gas exiting from the at least one battery cell and flowing along the at least one gas discharge path flows through at least one of the holes.

The chamber can therefore advantageously be designed in such a way that the gas introduced into it flows through, in particular must flow through, at least one of the holes in the first perforated plate to be able to reach the outlet opening of the chamber. By passing the harmful gas through such first holes, multiple effects can advantageously be achieved at the same time. On the one hand, the gas is slowed down as it flows through, which in turn allows the gas to cool down, and on the other hand, particles are deposited on this perforated plate. In addition, as the gas flows through it, it hits the first perforated plate and in particular also areas of the first perforated plate where no first holes are present. As a result of the gas and the particles contained therein hitting the first perforated plate, the perforated plate heats up, whereby energy is transferred from the gas to the first perforated plate, which in turn causes the gas and the particles contained therein to cool down. The result is that the gas exiting from the outlet opening is ultimately significantly cooled and contains significantly fewer particles, such that the overall risk of ignition of the exiting gas is enormously reduced or ignition can even be ruled out. Since such a first perforated plate is provided within a chamber, a very large overall volume can advantageously be converted through the chamber. This is again an advantage because the gas expands when it enters this large overall volume and therefore also cools down additionally. In contrast to tortuous gas channels used for particle separation, such a large total volume significantly reduces the likelihood of bottlenecks becoming clogged by separated particles. The number and size of the holes in the perforated plate can easily be adapted to the cell chemistry used and, for example, to the number of battery cells included in the battery, the gases of which are to be introduced into the chamber in question. This makes it particularly easy to adjust the settings to optimize the effect. In this way, safety in the event of outgassing from battery cells can be significantly increased in a particularly simple and cost-effective manner, and it can be ensured that gas exiting from a cell can be discharged in such a way that it is sufficiently cooled and contains fewer particles when it finally exits the outlet opening.

In general, when a gas is mentioned within the scope of the present invention, this should always be understood to mean a gas exiting or having exited from the at least one battery cell, for example in the course of a defect in the battery cell or thermal runaway mode of the battery cell. As described above, such a gas can also include particles. The gas exiting from such a battery cell therefore represents a gas-particle mixture. The gas exiting or exited from the at least one battery cell can therefore also be understood to mean a gas-particle mixture. The cell degassing channel may have a channel wall that separates an interior of the cell degassing channel from an exterior or environment. The same applies to the chamber, which is considered part of the cell degassing channel. The chamber can therefore have chamber walls that define the interior space of the chamber or delimit it from the surroundings. These chamber walls thus separate the interior space of the chamber from the exterior or surroundings of the chamber. On the one hand, the at least one inlet opening and also the at least one outlet opening can be provided in these chamber walls. These openings can also be exposable openings which, for example, are only opened when gas exits from the at least one battery cell. The openings can be closed, for example, by a bursting membrane or the like, which opens the corresponding opening in the event of excess pressure. However, the inlet opening and/or outlet opening can also be permanent openings. In general, multiple inlet openings and/or multiple outlet openings can be provided as well. In addition, the at least one inlet opening is now separated from the at least one outlet opening by the at least one first perforated plate arranged in the interior of the chamber. In other words, the first perforated plate divides the chamber into two subspaces, wherein the at least one inlet opening is arranged in a first of these two subspaces, and the at least one outlet opening is arranged in the other of the two subspaces. A gas introduced into the inlet opening must therefore pass through the perforated plate to reach the outlet opening. This applies likewise in the event that multiple inlet openings and/or outlet openings are provided.

The perforated plate can have numerous holes, in particular more than ten, particularly preferably more than 50. In particular, the first perforated plate can have a number of first holes, which is in the high two-digit range or even in the three-digit range. A number of holes in the four-digit range or more is also possible. The specific design can depend on multiple factors, for example the cell chemistry used for the at least one battery cell, the number of battery cells, and so on. For example, such a chamber can be provided per battery cell or per battery module with multiple battery cells, or even a single such chamber can be provided for the entire high-voltage battery of a motor vehicle, which, for example, has multiple battery modules, each with multiple battery cells. Accordingly, both the chamber and the perforated plate can be suitably dimensioned. The direction of the gas discharge path, to which reference will be made frequently later, should accordingly be along the path in the direction from the at least one inlet opening to the at least one outlet opening.

Furthermore, the first perforated plate, as well as the other perforated plates explained in more detail below, are preferably made of a temperature-resistant material, for example a metal or a ceramic. A metallic material is particularly advantageous because it can also absorb and dissipate heat from the gas very quickly. Accordingly, the remaining components of the chamber and the cell degassing channel, in particular the chamber walls or channel walls, can also be made of metal and/or ceramic. The perforated plate can therefore be designed as a perforated sheet. The thickness of the plate in the flow direction can be very small and, for example, be a maximum of a few millimeters, for example, a maximum of five millimeters.

To enable controlled outgassing of a battery cell, such battery cells typically have exposable degassing openings. In particular, a respective battery cell has such a exposable degassing opening. The degassing opening of the at least one battery cell can be fluidically coupled to the chamber via an additional gas channel. This gas channel can then also be part of the cell degassing channel. The gas entering this gas channel is accordingly led via this gas channel to the inlet opening of the chamber. The degassing openings of battery cells can also be coupled directly to the chamber. In other words, the degassing opening of the at least one battery cell, and that of optional additional battery cells, can, for example, be directly coupled to the at least one inlet opening of the chamber. A separate additional gas channel to guide the gases is then not necessary.

The outlet opening can also represent the final outlet opening from which the gas ultimately exits the motor vehicle in which the cell degassing channel is used, for example. Alternatively, another exhaust channel can be connected to the outlet opening of the chamber, which channel leads to a final outlet opening of the motor vehicle. This offers more flexibility with respect to the positioning of the final exit opening.

In another very advantageous embodiment of the invention, the chamber has at least one second perforated plate which is arranged in the interior space of the chamber and has multiple second holes, wherein the second perforated plate is arranged along the gas discharge path downstream from the first perforated plate and at a distance from the first perforated plate. Such a second perforated plate can also achieve an additional filtering and cooling effect. The operating principle is the same as explained for the first perforated plate. To reach the outlet opening, the gas passes through at least one, in particular multiple, of the second holes. This second perforated plate also slows down the gas that has passed through the first perforated plate, and additional particles are separated. The second perforated plate can also be designed as described for the first perforated plate, for example made of a ceramic material or a metallic material. Accordingly, additional energy can be absorbed from the gas through the second perforated plate, which further cools down the gas. Through this additional second perforated plate, the interior space of the chamber is thus divided into at least three subspaces, namely a first subspace, a second subspace, and a third subspace. The at least one inlet opening and the at least one outlet opening are arranged in different subspaces, namely in those that are at the greatest distance from one another and which are separated from one another by at least one other of the subspaces. It can thus be achieved that the gas, which is introduced into the chamber through the inlet opening, has to pass through both perforated plates, namely the first perforated plate and the second perforated plate, in order to reach the at least one outlet opening. The at least one gas discharge path also leads through at least one of the second holes in the second perforated plate. Since the first perforated plate and the second perforated plate are arranged at a distance from one another and are not arranged directly on top of one another, so to speak, it can be ensured that the respective holes in the perforated plates do not become clogged. The filtering effect is therefore significantly more efficient, and a flow backlog or flow blockage can be prevented. The distance does not have to be large and can be a few millimeters or a few centimeters.

In a particularly advantageous embodiment of the invention, at least one of the second holes is smaller than at least one of the first holes. A multi-stage filter can thus advantageously be provided by the at least two perforated plates. This means that the particles can be separated gradually depending on their size. For example, larger particles can be filtered through the first perforated plate, and accordingly smaller particles can be filtered through the second perforated plate. In addition, it can also advantageously be achieved in this way that not all particles are deposited on the first perforated plate and the gas flow becomes backed up too much in the first perforated plate. The proportion of particles to be separated per perforated plate can be adjusted by the size of the holes in the respective perforated plates. In this way, gradual braking, separating and cooling of the gas flow can advantageously be achieved.

For example, all first holes can be of the same size and all second holes can also be of the same size, for example in terms of their area, and in particular also with the same geometry. In this case, all first holes are larger than all second holes, for example. However, it is also conceivable that the first holes have different sizes, for example different cross-sectional areas, and so do the second holes. In this case, it is preferred that an average first hole size, for example based on the whole area or the hole diameter, is larger than an average second hole size of the second holes. The average first or average second hole size can be defined as the mean of the hole sizes of all first holes or all second holes, respectively.

In principle, the holes can also be of any geometrical design, for example round, polygonal, elliptical, star-shaped, slotted, or the like. A round geometry is particularly advantageous because, on the one hand, it is very easy to implement and, on the other hand, it allows an isotropic filtering effect to be achieved.

In another very advantageous embodiment of the invention, the first holes are arranged according to a first hole pattern and the second holes are arranged according to a second hole pattern. The first hole pattern and the second hole pattern are designed such that the first holes are not aligned with the second holes in a first direction perpendicular to the first hole plate, in particular wherein none of the first holes is aligned with any one of the second holes. For example, if the first and second holes are each designed as circular holes with a hole center, the hole centers of the first holes and the hole centers of the second holes do not lie on a line that runs parallel to the first direction. If an imaginary line is drawn parallel to the first direction through the center of a first hole, then there is no center of a second hole on this line. This applies to all first holes. In this way, it can advantageously be achieved that the gas is diverted as it flows through the perforated plates. The gas flow cannot simply pass through the holes in a straight line. This means that the braking effect of the gas, as well as the particle-separating effect, can be significantly increased.

The first hole pattern and the second hole pattern can, for example, also be designed such that a respective one of the first holes does not completely overlap with any of the second holes with respect to the first direction and only partially overlaps with at least one of the second holes or does not overlap with any of the second holes. If looking from the first direction at the first perforated plate and through one of the first holes, it may be that the second holes of the second perforated plate behind it are either only partially visible through this first hole, for example only a part of a second hole or only a part of multiple second holes is visible through a first hole, or even no part of a second hole at all.

In another advantageous embodiment of the invention, the chamber has at least one third perforated plate arranged in the interior of the chamber, which has multiple third holes, wherein the third perforated plate is arranged along the gas discharge path downstream from the first and second perforated plates and at a distance from the second perforated plate, wherein, in particular, at least one of the third holes is smaller than at least one of the second holes. In analogy to the second perforated plate, the filtering effect can also be increased by an additional third perforated plate. In this case, too, it is advantageous if the third holes are smaller than the second holes and also than the first holes. Likewise, only an average size of the third holes can be smaller than an average size of the second holes. However, all third holes are preferably the same size and therefore all third holes are smaller than all second holes. This simplifies manufacturing. These third holes can also be arranged at an offset with respect to the second perforated plate according to a third arrangement pattern, as has already been described for the second holes with reference to the first holes. This means that an additional deflection of the gas can be achieved as it passes through the three perforated plates. Otherwise, the third perforated plate can be designed as described above for the first and second perforated plates. The distance can also be selected as described above. This also applies to all optional additional perforated plates.

In principle, more than three such perforated plates can be provided. The number of perforated plates can be selected appropriately depending on the situation and application. However, a single-digit number of perforated plates is preferred.

Therefore, it is another advantageous embodiment of the invention if the chamber has multiple perforated plates arranged in the interior space of the chamber, comprising the at least one first perforated plate, wherein a respective perforated plate has multiple holes, wherein the perforated plates are arranged one behind the other along the at least one gas discharge path, and wherein an average hole size of the holes of a respective identical perforated plate is reduced from perforated plate to perforated plate in the direction of the at least one gas discharge path. The average hole size of a perforated plate is defined as the mean of the hole sizes of all holes of the same perforated plate, for example, as described above for the first, second and third perforated plates. The multiple perforated plates can also comprise the second perforated plate already described above and also the third perforated plate. In addition, a fourth perforated plate, a fifth perforated plate, and so on can be provided, for example. The sizes or at least average sizes of the respective holes preferably decrease from perforated plate to perforated plate. In addition, a total passage area varying, for example decreasing, from perforated plate to perforated plate, that is, the sum of all perforated areas of the holes in the same plate, can optionally be provided for the gas, or the total passage area can remain constant. In addition, in this case, too, the respective perforated plates can be arranged at an offset from one another, in particular offset from one another at least in pairs, such that the holes of the perforated plates following one another in the first direction are not aligned with one another, as already described.

Furthermore, it is very advantageous if the first holes have a respective hole area of at least 0.7 square millimeters and a maximum of 80 square millimeters. This can be achieved, for example, by circular holes with a diameter of at least one millimeter and at most ten millimeters. If multiple perforated plates are provided, as described above, it is preferred, for example, that the first holes have a diameter greater than five millimeters, e. g. 6 millimeters, and the third holes have a diameter smaller than two millimeters, e. g. 1.5 millimeters.

In another very advantageous embodiment of the invention, the chamber has a collecting basin for collecting particles deposited on the at least one first perforated plate, which is arranged in a lower half of the chamber with respect to gravity. This collecting basin is preferably located in an area of the chamber with little or no flow. In particular, this collecting basin can be provided as a kind of depression in a lower chamber wall or can be designed as a trough or the like, for example. The particles separated at the respective perforated plates can thus simply fall down into this collecting basin. This means they do not block the flow path through the chamber. Since this collecting basin is located in the lower part of the chamber, the at least one first perforated plate, as well as the optional further perforated plates, can also have no holes in a lower part, in particular in the lower part corresponding to this collecting basin. The gas flow can thus be led specifically above this collecting basin.

Furthermore, the invention also relates to a battery arrangement having a cell degassing channel according to the invention or one of its embodiments. The battery arrangement can additionally have the battery with the at least one battery cell. The battery is coupled to the cell degassing channel in such a way that a gas exiting from the battery cell can be introduced into the cell degassing channel, in particular into its chamber.

The battery can be a high-voltage battery, for example. The battery can comprise not only a single battery cell, but also multiple battery cells, in particular numerous battery cells, for example. These can basically be as round cells, prismatic cells, or pouch cells. The at least one battery cell can be formed as a lithium-ion cells, for example. If the battery comprises multiple battery cells, these can optionally be combined into battery modules. In other words, the battery can comprise multiple battery modules, each of which comprising multiple battery cells. The described cell degassing channel with the chamber can be provided per battery cell or per battery module or also for the entire battery. In other words, the battery can only have one cell degassing channel with such a chamber into which the gases of all cells of the battery that may be degassing are introduced. Alternatively, the battery can also have multiple cell degassing channels with respective such chambers, for example per battery module or even per battery cell. It is also conceivable that a shared cell degassing channel is used for multiple battery cells and/or battery modules, but that this channel has multiple such chambers, such as one per module or per cell. Furthermore, it is conceivable that the battery cell is arranged in relation to the chamber in such a way that the gas exiting from an exposable degassing opening assigned to the battery cell can be introduced directly into the chamber or, alternatively, indirectly via an additional degassing channel section, which was previously also referred to as a gas channel. There are also numerous possibilities with respect to the arrangement of the chamber in relation to the battery cell or the battery, which in principle have no limits.

Furthermore, a motor vehicle having a battery arrangement according to the invention or one of its embodiments should also be regarded as included in the invention.

The motor vehicle according to the invention is preferably designed as an automobile, in particular as a passenger car or truck, or as a passenger bus or motorbike.

Furthermore, the invention also relates to a method for discharging gases from a battery with at least one battery cell by means of a cell degassing channel which has a chamber into which a gas exiting from the at least one battery cell is introduced through at least one inlet opening and through which the gas is led along at least one gas discharge path to at least one outlet opening of the chamber. Furthermore, the chamber has at least one first perforated plate which is arranged in an interior space of the chamber and has multiple first holes, wherein the gas exiting from the at least one battery cell and flowing along the at least one gas discharge path flows through at least one of the first holes.

The advantages described for the cell degassing channel according to the invention and its embodiments thus apply likewise to the method according to the invention.

The invention also includes refinements of the method according to the invention, which have features as already described in the context of the refinements of the cell degassing channel according to the invention and the battery arrangement according to the invention. For this reason, the corresponding refinements of the method according to the invention are not described again here.

The invention also comprises the combinations of the features of the described embodiments. The invention therefore also comprises implementations that respectively have a combination of the features of multiple of the described embodiments, provided that the embodiments have not been described as mutually exclusive.

### BRIEF DESCRIPTION OF THE FIGURES

Exemplary embodiments of the invention are described hereinafter. Wherein:

FIG. 1 shows a plan view of a schematic representation of a battery arrangement with a cell degassing channel according to an exemplary embodiment of the invention;

FIG. 2 shows a schematic representation of a first perforated plate for a chamber of the cell degassing channel according to an exemplary embodiment of the invention;

FIG. 3 shows a schematic representation of a second perforated plate for a chamber of the cell degassing channel according to an exemplary embodiment of the invention;

FIG. 4 shows a schematic representation of a third perforated plate for a cell degassing channel according to an exemplary embodiment of the invention;

FIG. 5 shows a schematic and representation of a part of the chamber from FIG. 1 according to an exemplary embodiment of the invention; and

FIG. 6 shows a side view of a schematic representation of a battery arrangement from FIG. 1 according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

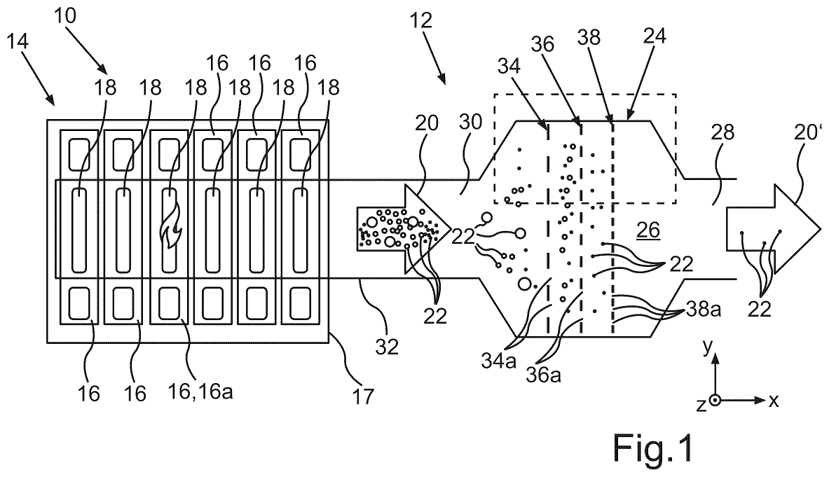

FIG. 1 shows a schematic representation of a battery cell arrangement 10 with a cell degassing channel 12 according to an exemplary embodiment of the invention. In addition to the cell degassing channel 12, the battery arrangement 10 has a battery 14 which comprises at least one battery cell 16. In the present example, the battery 14 comprises multiple battery cells 16. These can be arranged in a battery housing 17. Each respective battery cell 16 has an exposable cell degassing opening 18. Such an exposable degassing opening 18 can be provided by an opening in the cell housing of the cells 16, for example, which opening is closed by a bursting membrane during normal operation. In the event of a defect in a battery cell 16, as in this example of a battery cell 16a, this opening 18 can open due to the excess pressure created in the cell 16, whereby the cell 16 can outgas in a controlled manner. To remove the gas 20, which actually represents a gas-particle mixture 20 and, in addition to gas molecules, also comprises hot and in particular electrically conductive particles 22, in a controlled manner from the battery 14 and in particular from the motor vehicle in which the battery arrangement 10 is arranged, the battery arrangement 10 further has the already mentioned degassing channel 12. This channel comprises a chamber 24 with an interior space 26 into which the gas 20 exiting from the cell 16a can be introduced and through which this introduced gas 20 can be led to an outlet opening 28 of the chamber 24. The gas 20 can be introduced into the chamber 24 through a corresponding inlet opening 30. In principle, it is also conceivable to provide multiple inlet openings 30 and multiple outlet openings 28. In this example, the cell degassing channel 12 has another channel section 32 into which the gas 20 exiting from the cells 16 can be introduced and which is in particular directly coupled to the cell degassing openings 18. The gas 20 introduced into this channel section 32 is led therethrough to the inlet opening 30 of the chamber 24, to which this channel section 32 is fluidically connected. However, it would also be conceivable to eliminate this additional channel section 32 and to couple the chamber 24 directly to the battery 14, such that the gas 20 exiting from the cells 16 can be introduced directly into the chamber 24 through corresponding inlet openings 30. The chamber 24 can therefore be provided as a separate housing, for example per module or per battery 14, and it is also conceivable that the chamber 24 can be designed as an extension of the gas channel 32, that is, the gas channel section 32 described above.

The gas 20 introduced into the chamber 24 in the present example is very hot and, as already mentioned, contains numerous particles 22. For reasons of clarity, only some of these particles 22 are provided with a reference numeral. The chamber 24 can now advantageously provide a significant cooling of this gas 20 entering the chamber 24, as will now be explained in more detail below.

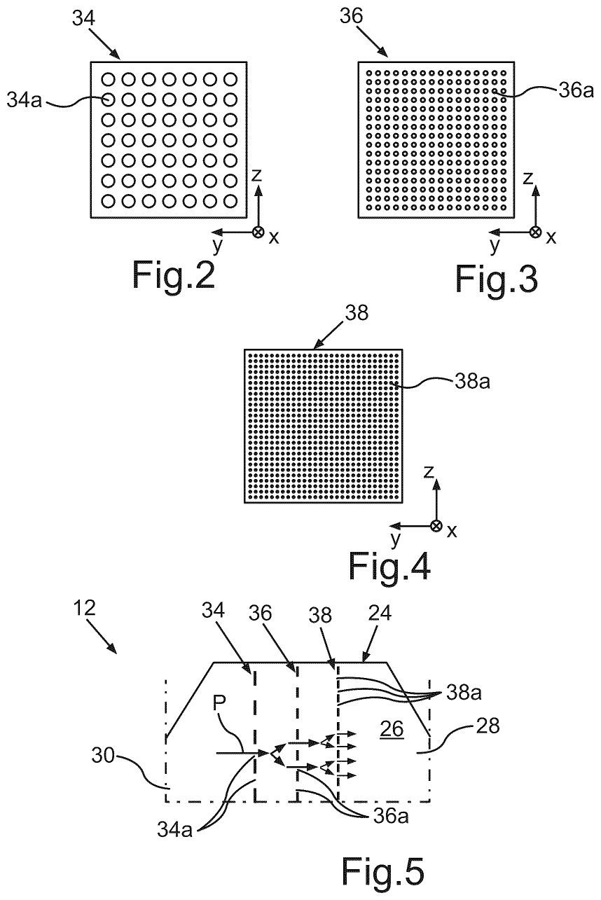

For this purpose, the chamber 24 has at least one perforated plate in the interior space 26. In the present example, three such perforated plates 34, 36, 38 are shown, namely a first perforated plate 34, a second perforated plate 36, and a third perforated plate 38. The first perforated plate 34 has multiple first holes 34a, the second perforated plate 36 has multiple second holes 36a, and, correspondingly, the third hole plate 38 has multiple third holes 38a. The first holes 34a are larger than the second holes 36a, and these in turn are larger than the third holes 38a. This allows to provide gradual separation of the gas 20 and filtering of the particles 22. Particles 22, as also illustrated in FIG. 1, are deposited on each of these perforated plates 34, 36, 38. Accordingly, the final gas flow 20′ exiting from the outlet opening 28 has significantly less particles 22 than the incoming gas flow 20 and has also cooled significantly compared to the incoming gas flow 20. The individual perforated plates 34, 36, 38 are shown again in detail in a respective plan view in FIG. 2, FIG. 3 and FIG. 4.

FIG. 2 shows a plan view of a schematic representation of the first perforated plate 34, FIG. 3 shows a plan view of the second perforated plate 36, and FIG. 4 shows a plan view of the third perforated plate 38. As can be seen, the respective perforated plates 34, 36, 38 in this example have circular holes 34a, 36a, 38a. Furthermore, the respective holes 34a, 36a, 38a in this example for a respective perforated plate 34, 36, 38 are of the same size and arranged in a matrix, that is, in rows and columns. It would also be conceivable if a respective perforated plate 34, 36, 38 also had holes 34a, 36a, 38a of different sizes, also in other geometries, in particular with mixed geometries, and in particular in a different arrangement. There are in principle no limits to the arrangement and design options. However, it is advantageous if the respective holes 34a, 36a, 38a meet certain criteria. One is, as already mentioned, that the average hole size in the flow direction, which runs in the x direction in the example shown in FIG. 1, decreases from perforated plate to perforated plate. This can be achieved, for example, by making holes 34a, 36a, 38a increasingly smaller from perforated plate to perforated plate. Another very advantageous criterion is that the perforated plates 34, 36, 38 are preferably arranged at an offset from one another with respect to their hole patterns, such that a straight flow therethrough is not possible, as is schematically illustrated in FIG. 5.

FIG. 5 shows a schematic representation of a part of the chamber 24 from FIG. 1 with the three perforated plates 34, 36, 38. The arrows also illustrate a part of a flow path P, which in particular splits multiple times, along which the gas 20 introduced into the inlet opening 30 flows to the outlet opening 28. Because the holes 34a, 36a, 38a of the respective perforated plates 34, 36, 38 are arranged offset from one another, the gas flow is divided according to the branching flow path P and is thereby deflected multiple times. These offset hole patterns can therefore advantageously prevent direct flow. This in turn promotes the cooling process and the particle separation process.

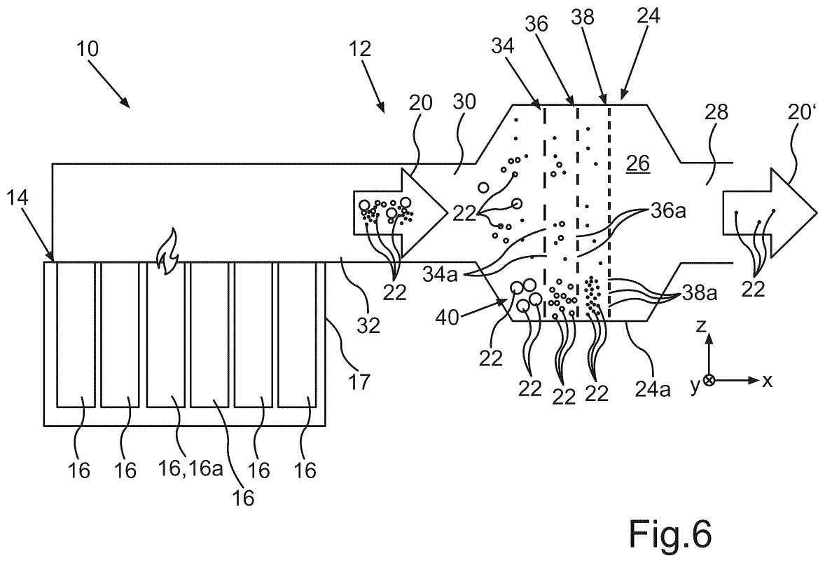

FIG. 6 shows another schematic side view of the battery arrangement 10 from FIG. 1. It can be seen here that the particles 22 deposited on the respective perforated plates 34, 36, 38 accumulate on the bottom 24a of the chamber 24. The chamber 24 can advantageously be designed with a collecting container 40 in which the separated particles 22 can accumulate. This collecting container 40 represents an area through which the gas flow 20 does not flow. In this area, the respective perforated plates 34, 36, 38 do not necessarily have to have holes 34a, 36a, 38a. In other words, the perforated plates 34, 36, 38 can also be designed in such a way that they do not have corresponding holes 34a, 36a, 38a in a lower region with respect to the cell direction. Thus, it can advantageously be achieved that the gas 20′ that eventually exits at the outlet opening 28 has cooled down and has only a few or no particles 22 left, such that this gas 20′ or the mixture can no longer ignite itself when it exits.

Overall, the examples show how the invention can provide a particle separator for battery systems which, in a preferred embodiment, makes it possible to gradually separate the particles depending on their size by means of multiple specially perforated sheets which are placed one behind the other and through which the harmful gas is led, due to their special design. A direct flow-through without deflection is excluded because the holes in the successive sheets are offset. The heat of the gas and the particles is transferred to the sheets.

1-10. (canceled)

11. A cell degassing channel for removing gases from a battery with at least one battery cell, wherein the cell degassing channel has a chamber,
which has at least one inlet opening;
which has at least one outlet opening; and
which is designed such that a gas exiting from the at least one battery cell can be introduced through the at least one inlet opening into the chamber, can be led through the same along at least one gas discharge path to at least one outlet opening of the chamber, and can be discharged from the least one outlet opening;
wherein the chamber has at least one first perforated plate arranged in an interior space of the chamber, which has multiple first holes, wherein the chamber is designed such that the gas exiting from the at least one battery cell and flowing along the at least one gas discharge path flows through at least one of the first holes.

12. The cell degassing channel according to claim 11, wherein the chamber has at least one second perforated plate arranged in the interior space of the chamber, which has multiple second holes, wherein the second perforated plate is located along the gas discharge path downstream from the first perforated plate and is arranged at a distance from the first perforated plate.

13. The cell degassing channel according to claim 12, wherein at least one of the second holes is smaller than at least one of the first holes.

14. The cell degassing channel according to claim 12, wherein the first holes are arranged according to a first hole pattern and the second holes are arranged according to a second hole pattern, wherein the first hole pattern and the second hole pattern are designed such that the first holes arranged in a first direction perpendicular to the first perforated plate are not aligned with the second holes, in particular wherein none of the first holes are aligned with any one of the second holes.

15. The cell degassing channel according to claim 12, wherein the chamber has at least one third perforated plate arranged in the interior space of the chamber, which has multiple third holes, wherein the third perforated plate is arranged along the gas discharge path downstream from the first and second perforated plates and at a distance from the second perforated plate, in particular wherein at least one of the third holes is smaller than at least one of the second holes.

16. The cell degassing channel according to claim 11, wherein the chamber has multiple perforated plates arranged in the interior space of the chamber, comprising the at least one first perforated plate, wherein a respective perforated plate has multiple holes, wherein the perforated plates are arranged one behind the other along the at least one gas discharge path, and wherein an average hole size of the holes of a respective same perforated plate is reduced from perforated plate to perforated plate in the direction of the at least one gas discharge path.

17. The cell degassing channel according to claim 11, wherein the first holes have a respective hole area of at least 0.7 mm2 and at most 80 mm2.

18. The cell degassing channel according to claim 11, wherein the chamber has a collecting basin for collecting particles deposited on the at least one first perforated plate, which is arranged in a lower half of the chamber with respect to gravity.

19. A battery arrangement with a cell degassing channel according claim 11, wherein the battery arrangement has the battery with the at least one battery cell.

20. A method for discharging gases from a battery with at least one battery cell by a cell degassing channel which has a chamber into which a gas exiting from the at least one battery cell is introduced through at least one inlet opening and through which the gas is led along at least one gas discharge path to at least one outlet opening of the chamber, wherein the chamber has at least one first perforated plate arranged in an interior space of the chamber, which has multiple first holes, wherein the gas exiting from the at least one battery cell and flowing along the at least one gas discharge path flows through at least one of the first holes.

21. The cell degassing channel according to claim 13, wherein the first holes are arranged according to a first hole pattern and the second holes are arranged according to a second hole pattern, wherein the first hole pattern and the second hole pattern are designed such that the first holes arranged in a first direction perpendicular to the first perforated plate are not aligned with the second holes, in particular wherein none of the first holes are aligned with any one of the second holes.

22. The cell degassing channel according to claim 14, wherein the chamber has at least one third perforated plate arranged in the interior space of the chamber, which has multiple third holes, wherein the third perforated plate is arranged along the gas discharge path downstream from the first and second perforated plates and at a distance from the second perforated plate, in particular wherein at least one of the third holes is smaller than at least one of the second holes.

23. The cell degassing channel according to claim 12, wherein the chamber has multiple perforated plates arranged in the interior space of the chamber (24), comprising the at least one first perforated plate, wherein a respective perforated plate has multiple holes, wherein the perforated plates are arranged one behind the other along the at least one gas discharge path, and wherein an average hole size of the holes of a respective same perforated plate is reduced from perforated plate to perforated plate in the direction of the at least one gas discharge path.

24. The cell degassing channel according to claim 13, wherein the chamber has multiple perforated plates arranged in the interior space of the chamber, comprising the at least one first perforated plate, wherein a respective perforated plate has multiple holes, wherein the perforated plates are arranged one behind the other along the at least one gas discharge path, and wherein an average hole size of the holes of a respective same perforated plate is reduced from perforated plate to perforated plate in the direction of the at least one gas discharge path.

25. The cell degassing channel according to claim 14, wherein the chamber has multiple perforated plates arranged in the interior space of the chamber, comprising the at least one first perforated plate, wherein a respective perforated plate has multiple holes, wherein the perforated plates are arranged one behind the other along the at least one gas discharge path, and wherein an average hole size of the holes of a respective same perforated plate is reduced from perforated plate to perforated plate in the direction of the at least one gas discharge path.

26. The cell degassing channel according to claim 15, wherein the chamber has multiple perforated plates arranged in the interior space of the chamber, comprising the at least one first perforated plate, wherein a respective perforated plate has multiple holes, wherein the perforated plates are arranged one behind the other along the at least one gas discharge path, and wherein an average hole size of the holes of a respective same perforated plate is reduced from perforated plate to perforated plate in the direction of the at least one gas discharge path.

27. The cell degassing channel according to claim 12, wherein the first holes have a respective hole area of at least 0.7 mm2 and at most 80 mm2.

28. The cell degassing channel according to claim 13, wherein the first holes have a respective hole area of at least 0.7 mm2 and at most 80 mm2.

29. The cell degassing channel according to claim 14, wherein the first holes have a respective hole area of at least 0.7 mm2 and at most 80 mm2.

30. The cell degassing channel according to claim 15, wherein the first holes have a respective hole area of at least 0.7 mm2 and at most 80 mm2.
